(19) United States
(12) Patent Application Publication
(10) Pub. No.: US 2009/0317622 A1
(43) Pub. Date: Dec. 24, 2009

(54) HIGH HARDNESS MAGNESIUM ALLOY COMPOSITE MATERIAL

(76) Inventors: Song-Jeng HUANG, Chiayi County (TW); Hui-Kan HSU, Yunlin County (TW); Tang-Hao CHIANG, Chiayi County (TW)

Correspondence Address: MCNEES WALLACE & NURICK LLC, 100 PINE STREET, P.O. BOX 1166, HARRISBURG, PA, 17108-1166, US

(21) Appl. No.: 12/352,831

(22) Filed: Jan. 13, 2009

(30) Foreign Application Priority Data
Jun. 24, 2008 (TW) 097123518

(51) Int. Cl. B32B 15/04

(52) U.S. Cl. 428/325

(57) ABSTRACT

A magnesium alloy composite material includes a magnesium alloy matrix, and a nanoparticle second phase material dispersed in the magnesium alloy matrix. The nanoparticle second phase material has an average particle size ranging from 1.0 nm to 100 nm. Preferably, the amount of the nanoparticle second phase material ranges from 0.05 wt % to 2.5 wt % based on total weight of the magnesium alloy composite material. With the addition of the nanoparticle second phase material to the magnesium alloy matrix, hardness can be increased to a relatively high level without significantly increasing density.

### CROSS-REFERENCE TO RELATED APPLICATION

This application claims priority of Taiwanese application no. 097123518, filed on Jun. 24, 2008.

### BACKGROUND OF THE INVENTION

1. Field of the Invention

This invention relates to a magnesium alloy composite material, more particularly to a magnesium alloy composite material having a nanoparticle second phase material therein.

2. Description of the Related Art

As 3C (communication, computer, and consumer) electronic products are getting lighter and smaller, there is a need to find materials having a lighter weight, higher hardness, tensile strength, and impact resistance suitable for the 3C products. Magnesium alloy is a known lightweight material (the density of which is two thirds that of aluminium, two fifths that of titanium, and one fourth that of stainless steel), and thus, there are many researches concerning improving the hardness, tensile strength, and impact resistance of the magnesium alloy.

Currently, in order to increase the hardness of a magnesium alloy, a well-known method is to add a second phase material, such as zirconium, rare earth metal, and/or a carbon-containing additive, to the magnesium alloy (for example, AZ91D magnesium alloy). Through the addition of the second phase material, a magnesium alloy can have an increased fine-grained structure and hence increased hardness.

However, the higher the hardness of the magnesium alloy has, the more difficult the working on the magnesium alloy is. Many researches manifest that, although addition of a large quantity of microparticles to a magnesium alloy can increase hardness and mechanical performance, it can also increase difficulty in processing of the magnesium alloy. Furthermore, because the microparticle materials generally used in the art are higher in density than the magnesium alloy as shown in the following Table 1, the more the microparticles is used, the more the density of the magnesium alloy is increased, thereby ruining the lightweight properties of the magnesium alloy. Therefore, how to maintain the lightweight properties of the magnesium alloy while adding the microparticles to increase hardness is an important issue for the industry.

TABLE 1

| | Density (g/cm³) |
|---|---|
| Microparticles | |
| Silicon nitride | 3.10 |
| Silicon carbide | 3.12 |
| Aluminum Oxide | 3.99 |
| Magnesium Oxide | 3.65 |
| Matrix | |
| Magnesium alloy (AZ91D) | 1.81 |
| Magnesium | 1.74 |

### SUMMARY OF THE INVENTION

Therefore, an object of the present invention is to provide a high hardness, lightweight magnesium alloy composite material containing a nanoparticle second phase material.

Accordingly, the invention provides a magnesium alloy composite material which comprises: a magnesium alloy matrix; and a nanoparticle second phase material dispersed in the magnesium alloy matrix, wherein the nanoparticle second phase material has an average particle size ranging from 1.0 nm to 100 nm.

Preferably, the amount of the nanoparticle second phase material ranges from 0.05 wt % to 2.5 wt % based on total weight of the magnesium alloy composite material.

It is known that nanoparticle second phase materials not only have high specific surface area, but also change in surface characteristics. It is also known that the nanoparticle second phase materials have reduced bulk densities. For example, the bulk density of the nanoparticle aluminum oxide is about 0.075 g/cm³. According to the present invention, it is discovered that, when the nanoparticle second phase material with the size ranging from 1.0 nm to 100 nm is added to the magnesium alloy, hardness can be increased considerably without significantly increasing weight.

### DETAILED DESCRIPTION OF THE PREFERRED EMBODIMENTS

The magnesium alloy matrix used in the magnesium alloy composite material according to the present invention may be any magnesium alloy that meets the standards for magnesium alloys. Examples thereof are AZ series magnesium alloys, AE series magnesium alloys, and AM series magnesium alloy. In the preferred embodiments of the present invention, AZ91D magnesium alloy, AE44 magnesium alloy, and AM60B magnesium alloy are used.

According to the present invention, the average particle size of the nanoparticle second phase material is limited to a range of from 1 nm to 100 nm. By limiting the particle size as such, an ultrafine-grained crystal structure can be developed effectively in the magnesium alloy composite material, thereby efficiently increasing the hardness thereof.

When the particle size of the nanoparticle second phase material is larger than 100 nm, because of the larger particle size, growth of the ultrafine-grained crystal structure will be inefficient so that the hardness of the magnesium alloy composite material cannot be increased effectively. On the other hand, if the particle size of the nanoparticle second phase material is smaller than 1 nm, the manufacture of such nanoparticle second phase material will encounter difficulties.

Preferably, the nanoparticle second phase material used in the invention is made from a ceramic material. The ceramic material may be selected from the group consisting of aluminum oxide, zirconium oxide, silicon carbide, and combinations thereof.

In a preferred embodiment, the nanoparticle second phase material is a nanoparticle aluminum oxide.

The amount of the nanoparticle second phase material added to the magnesium alloy matrix according to the present invention is set to be 0.05˜2.5 wt % based on total weight of the magnesium alloy composite material. If the amount of the nanoparticle second phase material is smaller than 0.05 wt %, formation of the ultrafine-grained crystal structure is insufficient, and hardness cannot be increased satisfactorily. On the other hand, if the amount of the nanoparticle second phase material is higher than 2.5 wt %, it is difficult for the nanoparticle second phase material to smelt into the magnesium alloy matrix to form a successful composite. By the addition of the nanoparticle second phase material in an amount of 0.05˜2.5 wt % based on total weight of the magnesium alloy composite material, it is possible to increase the hardness of the magnesium alloy composite material to a satisfactorily high level without significantly affecting the density of the magnesium alloy.

The present invention is explained in more detail below by way of the following examples and comparative example.

### EXAMPLES

Nanoparticle aluminum oxide was used in the examples. As listed in Tables 2-4, the particle sizes in the examples are 15˜20 nm, and 90 nm, and the particle size in the comparative example is 150 nm. The magnesium alloy matrices used in the examples include AZ91D magnesium alloy, AM60B magnesium alloy, and AE44 magnesium alloy.

In each example, the magnesium alloy composite material was produced by smelting the nanoparticle aluminum oxide into the magnesium alloy matrix at 570˜770° C. under atmospheric pressure. The hardness and density of the magnesium alloy composite material for each of the examples and the comparative example are shown in Table 2 (AZ91D magnesium alloy), Table 3 (AM60B magnesium alloy), and Table 4 (AE44 magnesium alloy).

The hardness was measured using a Vickers Hardness Tester (Taiwan Nakazawa Co., Ltd., model: MV-1). The density was measured using a specific gravity meter (TENPIN Co., Ltd., model: MH-200E).

TABLE 2

| | | Particle | Particle | Average | |
|---|---|---|---|---|---|
| | | size | percentage | hardness | Density |
| | Matrix | (nm) | (wt %) | (HV) | (g/cm³) |
| Matrix | AZ91D | — | — | 61.20 | 1.812 |
| Ex. 1 | AZ91D | 15~20 | 0.05 | 67.60 | 1.817 |
| Ex. 2 | AZ91D | 15~20 | 0.10 | 66.19 | 1.814 |
| Ex. 3 | AZ91D | 15~20 | 0.15 | 67.90 | 1.825 |
| Ex. 4 | AZ91D | 15~20 | 2.5 | 68.40 | 1.779 |
| Ex. 5 | AZ91D | 90 | 1.0 | 67.55 | 1.804 |
| Comp. | AZ91D | 150 | 1.0 | 64.50 | 1.811 |
| Ex. | | | | | |

TABLE 3

| | | Particle | Particle | Average | |
|---|---|---|---|---|---|
| | | size | percentage | hardness | Density |
| | Matrix | (nm) | (wt %) | (HV) | (g/cm³) |
| Matrix | AM60B | — | — | 48.16 | 1.786 |
| Ex. 6 | AN60B | 15~20 | 0.10 | 48.90 | 1.783 |
| Ex. 7 | AM60B | 15~20 | 1.0 | 48.53 | 1.782 |
| Ex. 8 | AM60B | 15~20 | 2.0 | 51.04 | 1.785 |

TABLE 4

| | | Particle | Particle | Average | |
|---|---|---|---|---|---|
| | | size | percentage | hardness | Density |
| | Matrix | (nm) | (wt %) | (HV) | (g/cm³) |
| Matrix | AE44 | — | — | 45.33 | 1.818 |
| Ex. 9 | AE44 | 15~20 | 0.10 | 49.91 | 1.817 |
| Ex. 10 | AE44 | 15~20 | 1.0 | 48.64 | 1.816 |
| Ex. 11 | AE44 | 15~20 | 2.0 | 51.30 | 1.813 |

The results in Tables 2, 3, and 4 show that by adding the nanoparticle aluminum oxide with sizes ranging from 10˜90 nm to the magnesium alloy matrix, the hardness of the magnesium alloy composite material can be increased by up to 13%. The results also show that, when the particle size having 150 nm (larger than 100 nm) is added in an amount of 1.0 wt % (see comparative example in Table 2), the hardness thereof is 64.5 that is even lower than that (67.6) of example 1 containing only 0.05 wt % of the nanoparticle aluminum oxide. From the result, it is evident that, when the particle size is smaller than 10 nm, even with a small amount (0.05˜0.1 wt %) of the added nanoparticle aluminum oxide, the hardness can be increased to a relatively higher level compared to the particle size larger than 100 nm. This is because the particle size smaller than 100 nm provides increased specific surface area, and that a very small amount of the nanoparticle aluminum oxide can effectively promote the growth of the ultrafine-grained crystal structure.

The results further show that, although the hardness of the examples increases considerably, the density of the magnesium alloy composite material increases or decreases slightly. Thus, the influence of the added nanoparticle aluminum oxide on the density of the magnesium alloy composite material is minimal. The reason is that the amount of the nanoparticle aluminum oxide needed to obtain high hardness can be minimized according to the present invention without affecting the development of the ultrafine-grained crystal structure.

On the other hand, it is found that, when the added amount of the nanoparticle second phase material is lower than 2.5%, the change in density of the magnesium alloy composite material is less than 1.8%. When the added amount is higher than 2.5%, it is difficult to smelt the nanoparticle second phase material into the magnesium alloy matrix and to form a successful composite.

With the addition of the nanoparticle second phase material having an average particle size smaller than 100 nm to the magnesium alloy matrix according to the invention, hardness can be increased to a lever higher than that achieved by the conventionally used microparticles without significantly increasing density. Therefore, a magnesium alloy composite material according to the invention not only has high hardness and high abrasion resistance but also exhibits lightweight properties.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A magnesium alloy composite material, comprising:
a magnesium alloy matrix; and
a nanoparticle second phase material dispersed in the magnesium alloy matrix,
wherein the nanoparticle second phase material has an average particle size ranging from 1.0 nm to 100 nm.

2. The magnesium alloy composite material of claim 1, wherein the nanoparticle second phase material is made from a ceramic material.

3. The magnesium alloy composite material of claim 2, wherein the amount of the nanoparticle second phase material ranges from 0.05 wt % to 2.5 wt % based on total weight of the magnesium alloy composite material.

4. The magnesium alloy composite material of claim 3, wherein the ceramic material is selected from the group consisting of aluminum oxide, zirconium oxide, silicon carbide, and combinations thereof.

5. The magnesium alloy composite material of claim 4, wherein the magnesium alloy matrix is selected from the group consisting of AZ series magnesium alloys, AM series magnesium alloys, and AE series magnesium alloys.

6. The magnesium alloy composite material of claim 4, wherein the magnesium alloy matrix is selected from the group consisting of AZ91D magnesium alloy, AM60B magnesium alloy, and AE44 magnesium alloy.
